(19) United States
(12) Patent Application Publication
(10) Pub. No.: US 2003/0174124 A1
(43) Pub. Date: Sep. 18, 2003

(54) Method and apparatus of obtaining mouse operation at finger tip

(76) Inventor: Hoton How, Belmont, MA (US)

Correspondence Address: Hoton How, 262 Clifton Street, Belmont, MA, 02478, US

(21) Appl. No.: 10/094,877

(22) Filed: Mar. 12, 2002

(51) Int. Cl. G09G 5/08

(52) U.S. Cl. 345/167

(57) ABSTRACT

Disclosed is a method and an apparatus enabling operation of a mini-mouse which is installed at the tip of an finger. Three advantages result by using a mouse at finger tip. First, the mouse can be applied to and hence manipulated by a thumb so that the mouse operation is consistent with the action of typing involving a keyboard. By doing so the typing action is not much disturbed by the mouse operation. Secondly, the mouse at finger tip provides the function of an input-pen device to be applied to surfaces of any kind, not necessarily to be restricted to a finite window imposed by a special pad. Thirdly, the disclosed mouse device shows a compact size providing effective control over cursor movement with ease and efficiency. This last advantage is most desired by a handheld computer.

### FEDERALLY SPONSORED RESEARCH

(Not Applicable)

### SEQUENCE LISTING OR PROGRAM

(Not Applicable)

### BACKGROUND

1. Field of Invention

This invention is directed to a method and an apparatus to obtain mouse operation at finger tip. A mini-mouse is attached to a cap to be applied at the tip of a finger. As such, operation of a mouse is convenient, within the reach of finger tips, providing not only the basic functions of a mouse, but also additional usage supplied by an input-pen device, for example.

2. Prior Art

Typically, operation of a mouse required by the prior art is inconsistent with the action of typing, and fingers have to temporarily leave their pre-assigned positions on a keyboard to change the knocking action into other kinds, either scraping against an electrostatic pad or grasping the mouse holder making the mouse ball to roll on a surface. Both actions can interrupt the typing action appreciably and hence slowing down the speed in typing, especially when typing involves graphic management requiring frequent cursor movement on a computer screen, performing the tasks of selecting, cutting, copying, pasting, and scrolling, etc.

The conventional mouse has no way to input writing strokes on data entering. To quantify the coordinates of a graphic curve printed on a magazine page, for example, it can neither provide any help. Although these two functions can be performed by an input-pen device available commercially, the use of an input-pen device is further inconsistent with the typing action assumed by a keyboard, and hence distracting more the typing action, besides it is a second device in addition to the mouse device. More seriously, the current input-pen device is required to be used with a special pad, and the operation is restrict to a finite window provided by the pad, to be either electrostatic, piezoelectric, or optic in nature. Currently, it is almost impossible to enter graphic data appearing on a hard surface, for example, a printed curve pasted on the wall.

For a handheld it is too luxury to implement a mouse of the traditional kind, and data input is accomplished by using a special pen, called stylus, exerting pressure on a stress-sensitive screen-pad on entering writing strokes. Although a folded keyboard is now commercially available, but not a folded mouse. Thus, technologies for data entering involving a handheld are still lacking.

### OBJECTS AND ADVANTAGES

Accordingly, it is an object of the invention to address one or more of the foregoing disadvantages or drawbacks of the prior art, and to provide such an improved method and apparatus to obtain mouse operation at finger tip. This allows the typing action using a keyboard not to be disturbed or interrupted by the other actions tempting to control the cursor movement on the computer screen, facilitating data input at high speeds. A mouse at finger tip provides dual functions of a conventional mouse and an input-pen device, but assuming a rather compact size. In contrast to a conventional input-pen device, a “mouse-pen” can be applied to surfaces of any kind, not necessarily to be restricted to a finite window imposed by a special pad. Also, a mouse equipped at finger tip is desired when working with a handheld, performing the required functions at convenience without increasing much the overall volume.

Other objects will be apparent to one of ordinary skill, in light of the following disclosure, including the claims.

### SUMMARY

In one aspect, the invention provides a method which sets up mouse action at finger tip, allowing for text typing and mouse operation to be performed consistently, without requiring the fingers to leave the pre-assigned positions for typing on the keyboard, performing the tasks of cursor movement, selecting, copying, cutting, pasting, and scrolling, etc . . . Furthermore, the disclosed method allows the mouse at finger tip to be manipulated like a pen, performing graphic-data input such as entering a writing stroke or outlining the trace of a printed curve. A mouse pen will work on any surface, not necessarily to be restricted to a finite window located on a special pad, as assumed by a conventional input-pen device. A mouse at finger tip can be preferentially used with a handheld, performing the normal functions of a mouse but rather at a compact size.

In another aspect, the invention provides an apparatus which sets up mouse action at finger tip, allowing for text typing and mouse operation to be performed consistently, without requiring the fingers to leave the pre-assigned positions for typing on the keyboard, performing the tasks of cursor movement, selecting, copying, cutting, pasting, and scrolling, etc . . . Furthermore, the disclosed apparatus allows the mouse at finger tip to be manipulated like a pen, performing graphic-data input such as entering a writing stroke or outlining the trace of a printed curve. A mouse pen will work on any surface, not necessarily to be restricted to a finite window located on a special pad, as assumed by a conventional input-pen device. A disclosed apparatus is desired by a handheld, performing the normal functions of a mouse but rather at a compact size.

### DRAWINGS

Figures

For a more complete understanding of the nature and objectives of the present invention, reference is to be made to the following detailed description and accompanying drawings, which, though not to scale, illustrate the principles of the invention, and in which:

FIG. 1A shows one example of the preferred embodiment of the invention that a mini-mouse is illustrated to be installed at the tip of a finger. The size of a thumb is also indicated for the purpose of comparison.

FIG. 1B shows the same example of FIG. 1A of the preferred embodiment of the invention to reveal its operation on entering graphic data, for example, a writing stroke. The mini-mouse shown in FIG. 1A is worn by the thumb with a button being pressed by the index finger while the mouse ball is rolling on top of a surface depicting the track of the stroke composing the text.

FIG. 1C shows the same example of FIG. 1A of the preferred embodiment of the invention to reveal its operation as a convenient cursor-control device. The mini-mouse shown in FIG. 1A is worn by the thumb with a button being pressed by the index finger while the middle finger is scratching against the mouse ball making it to rotate so as to control cursor movement on a computer screen.

### REFERENCE NUMERALS

| | |
|---|---|
| 100 | Mini-Mouse to be Installed at Finger Tip |
| 110 | Bowl to Contain Mouse Ball |
| 120 | Mouse Ball |
| 131, 132 | Bowl Supporting Arm |
| 141, 142 | Bowl Pivoting Support (Optional) |
| 150 | Slip Ring (Optional) |
| 160 | Cap to be Worn by a Finger |
| 171 | Top Button (Left Button of Normal Mouse) |
| 172 | Bottom Button (Right Button of Normal Mouse) |
| 180 | Cable |
| 181 | Adaptor |
| 182 | Transmitter/Battery/Watch (Optional) Assembly |
| 183 | Belt |
| 190 | Thumb |
| 191 | Wrist |
| 192 | Index Finger |
| 193 | Middle Finger |

### DETAILED DESCRIPTION

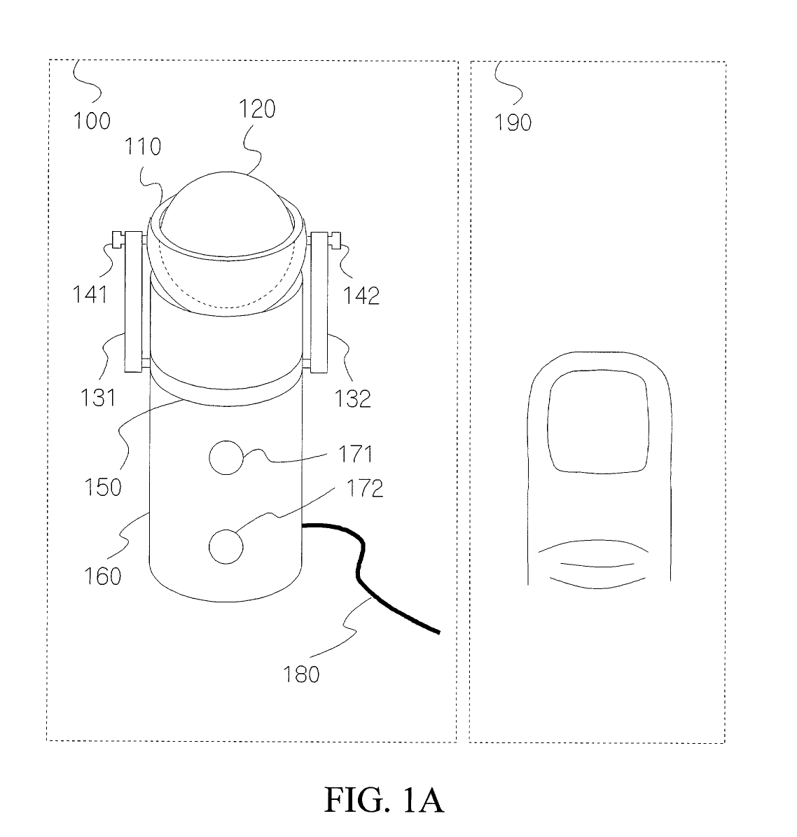

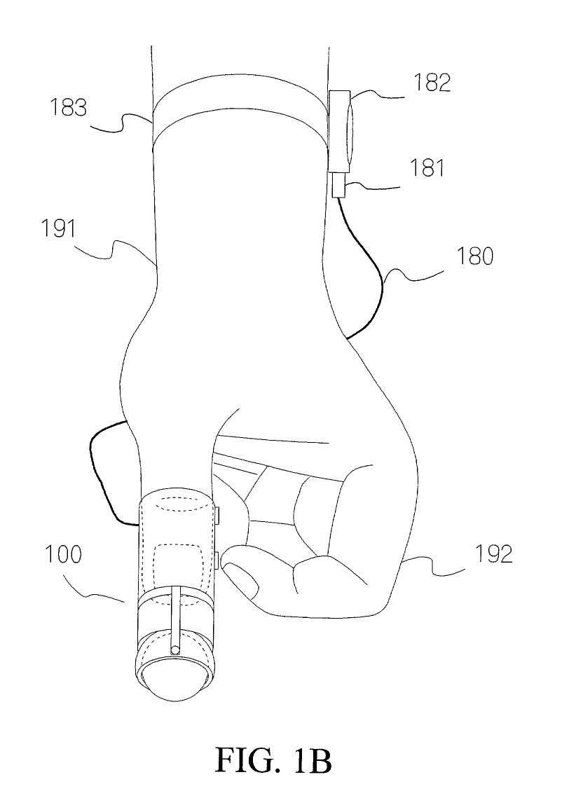

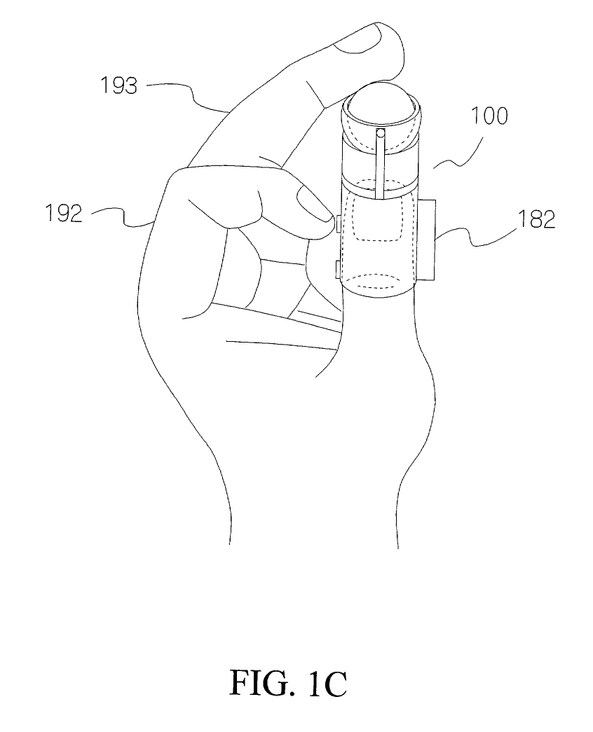

Preferred Embodiment:—FIG. 1A

FIG. 1A shows one example of the preferred embodiment of the invention that Mini-Mouse 100 is illustrated to be installed at the tip of a finger, say, Thumb 190. Mini-Mouse 100 includes Mouse Ball 120 to be contained in Bowl 110 capable of performing rotational motion there. The opening of Bowl 110 has a dimension smaller than Ball 120 so that once enclosed by Bowl 110, Ball 120 is not allowed to escape, contacting slightly with inside of Bowl 110 so as to enable precision measurement on the rotational motion of Ball 120. This is achieved by incorporating transducers inside Bowl 110 of either a mechanical kind or an optical kind, or other kinds, as installed with a conventional mouse contained in the prior art.

At two diametrically opposite positions Bowl 110 is hung rather firmly by Bowl Pivoting Supports 141 and 142 attached to Bowl Supporting Arms 131 and 132, respectively. This allows Bowl 110, and hence Ball 120, to point to different directions in reference to Bowl Supporting Arms 131 and 132. At the other ends Bowl Supporting Arms 131 and 132 are fastened to Slip Ring 150 surrounding Cap 160, and Cap 160 shows a hollow structure allowing a finger to be inserted in, for example, thumb, index finger, or middle finger, etc. In order to ensure tight fit of a finger, rubber, or other flexible materials, may be used to make up the inside wall of Cap 160. Top Button 171 and Bottom Button 172 are fabricated with Cap 160, providing the functions of left button and right button included with a conventional mouse, respectively.

The purpose of Slip Ring 150 is to allow Bowl 110, and hence Ball 120, to rotate at different orientations relative to Buttons 171 and 172, enabling sophisticated operation required by a complex device. For a primitive device intended to perform simple and specific tasks, Slip Ring is not necessary, and Bowl Supporting Arms 131 and 132 can then be directly attached to Cap 160. For the same purpose Bowl Pivoting Support 141 and 142 may also be removed for a primitive device, and Bowl 110 is directly attached to Cap 160 with Bowl Supporting Arms 131 and 132 omitted. More buttons or scrolling wheels in addition to Top Button 171 and Bottom Button 172 can be installed with Cap 160 to provide extra functions, such as scrolling control, or controls underlying the play of computer games. Although Cap 160 is illustrated in FIG. 1A, geometries other than a “CAP” can equally be used, for example, a pipe, a clamp, or a ring-cluster, etc. Thumb 190 is shown in FIG. 1A for the purpose of demonstrating the dimension of the disclosed device of Mini-Mouse 100.

Cable 180 shown in FIG. 1A is to acquire power from a battery supporting Mini-Mouse operation, as well as to deliver mouse signals to a transmitter. The mouse signals are derived from transducers installed inside Bowl 110. The transducer signals are coded or modulated in the form of radiation waves sent out in air by the transmitter. A receiver is located with the computer to retrieve back the transducer signals radiated from the transmitter, feeding into a computer to realize the mouse operation. Mouse operation includes control over the movement of the cursor on the computer screen plus other functions, such as selecting, copying, cutting, pasting, and scrolling, etc. The transmitter and receiver units are contained in the prior art. Battery and transmitter, which are shown in FIG. 1B and FIG. 1C, are not shown in FIG. 1A. Also, it is understood Cable 180 can be directed connected to the keyboard or computer without necessarily requiring the use of a transmitter and a receiver. However, Mini-Mouse 100 with direct cable connection, though simple, might be cumbersome in operation.

Mini-Mouse 100 is intended for joint operation with a keyboard. To operate Mini-Mouse 100 is applied at the tip of a thumb, being either the right-hand thumb or the left-hand thumb depending on whether the operator is a right-hand person or a left-hand person, respectively. To be specific, in the following discussion a right-hand person is assumed, requiring the use of a right-hand device. However, by incorporating Slip Ring 150 in FIG. 1A a right-hand device can be converted into a left-hand device, and vise versa. On tying using a keyboard all of the fingers except thumbs are assigned to specific letters located at fixed keyboard positions, and the two thumbs are “BOTH” assigned to the key of space bar. This redundancy implies freedom for one thumb, say, the right thumb, which is now equipped with a mouse performing the specified task of controlling cursor movement on a computer screen. As such, the original assignment to keyboard keys is unchanged, and hence the speed in typing will not be affected much.

When mouse operation is required and the cursor position is tempted to be moved across the computer screen, the right-hand thumb equipped with Mini-Mouse 100 at thumb tip then starts to scratch against whatever area available near the lower edge of the keyboard, including the margin of the keyboard or the part of the desk nearby, so long as the other four fingers of the right hand remain barely undisturbed. By doing this the mouse operation is compatible with text typing and hence the typing action is not distracted. In order to make the scratching action proper or effective, the direction of Mouse Bowl 110, and hence Mouse Ball 120, may need to be adjusted so that they point roughly normal to the scratching surface. Also, Mouse Ball 120 is assumed to provide sufficient friction on scratching so that Mouse Ball 120 is not slipping on rolling. As such, Mouse Ball 120 may be fabricated with rubber.

To perform the actions of, say, selection, copying, or pasting, the left button of a conventional mouse together with some other keys on the keyboard needs to be suppressed simultaneously, such as the Shift Key, the Control Key, and/or the Alternate key. These actions can also be performed by using the disclosed device of Mini-Mouse 100 shown in FIG. 1A: pressing Top Button 171 using the right index finger while at the same time hold the other required keys on the keyboard using the left fingers. This results in minor disturbance to the typing action, and the process of normal typing can be resumed back almost immediately after the mouse actions have completed. The dragging action is a little more complicated, and it requires Top Button 171 of Mini-Mouse 100 to be pressed along with the scraping motion of Ball 120. Again, this causes little problem, since one can still use his or her right index finger to press Top Button 171 while at the same time swaying the right thumb around near the keyboard edge to stimulate the scratping action of Mouse Ball 120. From the above discussions, it is thus clear that operating a mouse located at finger tip can certainly provide advantages over the prior art, giving rise to convenience and hence resulting in time saving when mouse operation is required along with text typing using a keyboard.

Mouse-Pen Operation:—FIG. 1B

FIG. 1B shows the same example of FIG. 1A of the preferred embodiment of the invention to reveal its operation on entering graphic data, including depicting a writing stroke, or tracing a curve printed on a newspaper, for example. Although graphic input may also be obtained by using an input-pen device contained in the prior art, however, an input-pen device is considered as a separate device to be complementary to a mouse performing different tasks. The combination of a mouse and an input-pen device shown in FIG. 1A is thus advantageous, because it provides dual functions on a single device. Unlike an input-pen device contained in the prior art, the mouse-pen device shown in FIG. 1A does not need a special pad to operate, and its writing can be applied to surfaces of any kind, including papers, books, walls, or even on top of a terrestrial globe, etc. As in contrast, the conventional device will require the writing or drawing to be applied to a finite window located on a special pad incorporating transducers of the electrostatic or the piezoelectric kind, or involving an optical grid upon operation.

To demonstrate Mouse-Pen operation on inputting graphic data of a writing stroke, for example, Mini-Mouse 100 shown in FIG. 1B is worn by the thumb with Top Button being pressed by Index Finger 192 while the mouse ball is rolling on top of a surface outlining the track of the stroke. In FIG. 1B Mini-Mouse 110 is the same as that shown in FIG. 1A and Cable 180 is connected to Transmitter/Battery/Watch Assembly 182 via Adaptor 181. Transmitter/Battery/Watch Assembly 182 is attached to Wrist 191 using Belt 183 in a manner similar to watch wearing. Transmitter/Battery/Watch Assembly 182 contains a battery conveying power to Mini-Mouse 100 on one hand, and transmits the transduced signals processed thereof on the other hand, as described previously. Receiver is located with the computer or with the keyboard which is not shown in FIG. 1B.

By using a disk battery, for example, a lithium battery or a mercury battery, together with an Integrated Circuit (IC) for the transmitter the size of Assembly 182 can be reduced, to be comparable to that of a watch. As such, a watch may be installed with Assembly 182, not only for aesthetic reasons, but also to provide multiple functions at one device. That is, even when Assembly 182 is not at duty providing service to a computer or a handheld, it can still be worn by the operator serving as a watch. At the time when mouse operation is called for, Mini-Mouse 100 is then inserted at thumb tip with Adaptor 181 plugged in. Of course, inclusion of Watch with Transmitter/Battery/Watch Assembly 181 is optional.

Also, it is understood that Mini-Mouse 100 is not necessary to be worn by the thumb, as contrasted to the situation discussed previously when text-data entering is attempted together with mouse operation at the same time. On entering text data a keyboard is used, and the only finger available for mouse operation is thus the thumb. However, on entering graphic data, a keyboard is not required, and hence the other fingers can equally be used for the mouse operation. In order to allow Mini-Mouse 100 to be operated by the other fingers, mouse ball orientation as well as its direction needs to be adjusted accordingly. This is done by pivoting Mouse Bowl 110 through Bowl Pivoting Support 141 and 142 and glides Slip Ring 150 onto desired orientations, as discussed previously with FIG. 1A.

Cursor-Control Operation:—FIG. 1C

FIG. 1C shows the same example of FIG. 1A of the preferred embodiment of the invention to reveal its operation as a convenient cursor-control device. In previous discussions the disclosed Mini-Mouse device is demonstrated either to assist text-data entering required by a keyboard, or to perform graphic data entering outlining a writing stroke or tracing a printed curve. For these two applications the ball of the mouse is assumed to touch against an external surface to initiate its operation. However, there are situations which require only a simple mouse operation, such as to move the cursor on the screen followed by pressing the confirm button, Top Button 171 of Mini-Mouse 100 shown in FIG. 1A. For example, on checking and reading e-mails or browsing across internet sites what is sufficient is to apply a Mini-Mouse at finger tip to perform cursor-control operation. The other operations, such as selection, coping, cutting, and pasting, are seldom needed. Cursor-control operations have been performed heavily and routinely by a handheld computer. A successful accessary to a handheld depends critically on its size, as well as on the efficiency and convenience that the accessory can handle cursor movement on handheld screen. The disclosed Mini-Mouse device shown with FIG. 1A fulfills fully these requirements.

Mini-Mouse 100 shown in FIG. 1C is worn by Thumb 190 with Top Button 171 being pressed by Index Finger 192 while Middle Finger 193 is scratching against the mouse ball making it to rotate accordingly. This accomplishes most of the tasks that require Mini-Mouse 100 to perform the cursor-control operation. Of course, Mini-Mouse 100 can be operated by using fingers other than a thumb, as just stated. For example, one may use his or her Middle Finger 193 to press Top Button 171 and use Index Finger 192 to roll over the ball. Different finger assignment may require the orientation and direction of Ball 130 shown in FIG. 1A to be adjusted, as discussed previously with FIG. 1A.

In FIG. 1C Transmitter/Battery Assembly 182 has been fabricated in a small volume sufficient to be attached to outside of Cap 160 shown in FIG. 1A. This is possible, since by using a compact disc battery together with an IC transmitter circuit the size of Transmitter/Battery Assembly 182 can be therefore reduced. Receiver is otherwise located with the computer or with the keyboard which is not shown in FIG. 1C. For the above discussions it is thus clear Mini-Mouse 100 can be used to provide cursor-control operation providing convenience and efficiency. Most importantly, Mini-Mouse 100 occupies a small volume, which manifests itself to be an ideal accessory providing service to a handheld.

### CONCLUSIONS

A mini-mouse applied at finger tips is desirable for three applications. The first application is to assist text-data entering when a keyboard is used. Since the operation of the mini-mouse is compatible with the text-typing action performed by the other fingers, its operation will distract little the typing action. The second application involves a mouse-pen operation. A mini-mouse can provide the function of a mouse-pen to input graphic data on surfaces of any kind. Thus, the disclosed mini-mouse has a wider range in applications than a conventional device does, which can only be applied to a finite area located on a special pad. The third application concerns effective cursor-control on the screen of a computer. Since cursor control is all performed within the reach of finger tips, it is thus convenient. Most importantly, a mini-mouse device shown with this invention exhibits a compact size, which is desirable by a handheld computer.

I claim:

1. A method of obtaining mouse operation at finger tip, comprising:
installing a mouse attached to a bearer both of which exhibit a lateral dimension compatible to the size of a finger,
wherein by mounting said bearer at said finger tip said mouse provides control over cursor movement on a screen display plus other functions, thereby enabling said mouse operation at said finger tip.

2. The method of claim 1 wherein said other functions include selecting, copying, cutting, pasting, dragging, scrolling, game controlling, etc.

3. The method of claim 1 wherein said mouse operation includes rolling said mouse on a surface manipulated by said finger tip.

4. The method of claim 1 wherein said mouse operation is induced by using another finger scraping said mouse so as to make it to rotate.

5. A mini-mouse device to be installed at the tip of a finger, comprising:
(A) a mouse whose size is compatible to the lateral dimension of said finger,
(B) a bearer which can be mounted to said finger at the position of said tip,
wherein, by attaching said mouse onto said bearer pointing toward a predetermined direction said mouse can be operated and manipulated by said finger together with other fingers, if necessary, thereby achieving mouse operation at finger tips.

6. The mini-mouse device of claim 5 wherein said mouse operation includes control over cursor movement on a screen display plus other functions such as selecting, copying, cutting, pasting, dragging, scrolling, game controlling, etc.

7. The mini-mouse device of claim 5 wherein said mouse operation is induced by scraping said mouse against a surface to be manipulated by said finger.

8. The mini-mouse device of claim 7 wherein said surface locates near a keyboard so that when operating or manipulating said mouse there is no need to move hands significantly away from said keyboard.

9. The mini-mouse device of claim 5 wherein said mouse operation is induced by using another finger scraping said mouse so as to make it to rotate.

10. The mini-mouse device of claim 5 wherein said bearer assumes the geometry of a cap which can be inserted over said finger at said position of said tip.

11. The mini-mouse device of claim 5 wherein said mouse operation is employed so as to acquire graphic data.

12. The mini-mouse device of claim 5 wherein said other fingers are involved in pressing buttons or rolling wheels located on said bearer.

13. The mini-mouse device of claim 5 wherein said mouse contains transducers of the mechanical type, or the optical type, or other types.
